(19) United States
(12) Patent Application Publication
(10) Pub. No.: US 2014/0172737 A1
(43) Pub. Date: Jun. 19, 2014

(54) COMMUNITY SHIPPING PLATFORM

(71) Applicant: Santhanakrishnan Natarajan Conjepuram, Fremont, CA (US)

(72) Inventor: Santhanakrishnan Natarajan Conjepuram, Fremont, CA (US)

(73) Assignee: eBay Inc., San Jose, CA (US)

(21) Appl. No.: 13/718,924

(22) Filed: Dec. 18, 2012

(51) Int. Cl. G06Q 10/08

(52) U.S. Cl. CPC G06Q 10/0834
USPC 705/333; 705/334; 705/335

(57) ABSTRACT

A system and method for a community shipping platform is described. A pool of community shippers operating within a geographical area including a geographical pickup location of a seller and a geographical delivery location of a buyer is identified. A request is generated to the pool of community shippers to fulfill a shipment from the geographical pickup location of the seller to the geographical delivery location of the buyer.

### TECHNICAL FIELD

This application relates generally to the field of computer technology, and in a specific example embodiment, a method and system for a fulfillment network.

### BACKGROUND

Online marketplaces include many sellers listing items for sale. Buyers buy these items and sellers ship the item to the buyer upon receipt of payment. Buyer and sellers may be located in different or the same geographical areas. Because of the few number of shipping service providers available to fulfill the shipment, prices for shipping remain high. Furthermore, the cost of shipping an item across several states may be only slightly more than the cost of shipping an item across town.

### BRIEF DESCRIPTION OF THE DRAWINGS

The present invention is illustrated by way of example, and not by way of limitation, in the figures of the accompanying drawings in which:

FIG. 1 is a network diagram depicting a network system, according to one embodiment, having a client-server architecture configured for exchanging data over a network;

FIG. 2 shows a block diagram illustrating one example embodiment of a publishing application;

FIG. 3 shows a block diagram illustrating one example embodiment of a community shipping platform application;

FIG. 4 shows a block diagram illustrating one example embodiment of a community shipper pool builder module;

FIG. 5 shows a block diagram illustrating one example embodiment of a community shipper operation module;

FIG. 6A shows a block diagram illustrating one example of a pool of community shippers in a geographic area;

FIG. 6B shows a block diagram illustrating one example of a request to a pool of community shippers in a geographic area of the buyer and seller;

FIG. 6C shows a block diagram illustrating one example of an operation of community shipper platform;

FIG. 7 shows a flow diagram illustrating one example embodiment of a method for generating a pool of community shippers;

FIG. 8 shows a flow diagram illustrating one example embodiment of a method for operating a community shipper platform;

FIG. 9 shows a flow diagram illustrating one example embodiment of a method for generating a compensation for a community shipper; and

FIG. 10 shows a diagrammatic representation of machine in the example form of a computer system within which a set of instructions may be executed to cause the machine to perform any one or more of the methodologies discussed herein.

### DETAILED DESCRIPTION

Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

A system and method for a community shipping platform is described. A pool of community shippers operating within a geographical area including a geographical pickup location of a seller and a geographical delivery location of a buyer identified. A request is generated to the pool of community shippers to fulfill a shipment from the geographical pickup location of the seller to the geographical delivery location of the buyer. In one embodiment, the pool of community shippers may be segmented into different groups based on their corresponding attributes that may be used for prioritization of the request. For example, a group of community shippers having high feedback ratings and located within the geographical pickup location of the seller and the buyer may be selected for the request over a group of community shippers having lower feedback ratings.

For example, an online marketplace, such as eBay, may provide a new category of marketplace participants, community shippers, in addition to buyers and sellers. Community shippers may include individuals or businesses who want to offer their shipping services for eBay marketplace transactions. Shippers, as part of their enrollment, provide their preferred working times, their address, and radius of operation. eBay sellers, in addition to regular shipping choices such as USPS, UPS, FedEx, can also offer community shipping platform (CSP) same-day shipping. Buyers, when buying items, can choose CSP shipping if offered by sellers and is available. Once a buyer buys from a local seller and chooses CSP shipping, eBay may message all available shippers (in the order of priority of their feedback rating) and the job could be picked up by the first shipper who responds. Once the community shipper accepts the job, the seller's pick up address may be messaged to the community shipper. The community shipper may coordinate a pick up time with the seller via a mobile application of eBay. Once they agree on a time, the community shipper arrives and picks up the item. Once pick up happens, eBay may message the buyer's address to community shipper. Then the community shipper coordinates a delivery time with the buyer via the mobile application of ebay. Once they agree on a time, the delivery is made. This is a point to point delivery where coordination among the three parties is facilitated by eBay via its web and mobile apps seamlessly. Close tracking and status updates are provided to the parties based on their notification preferences. As the volume of CSP usage increases, eBay may optimize shipping routes such that delivery time is minimized and number of packages carried by a shipper is maximized. As economies of scale are achieved, the cost of shipping may go down much below the current choices available.

### System Architecture

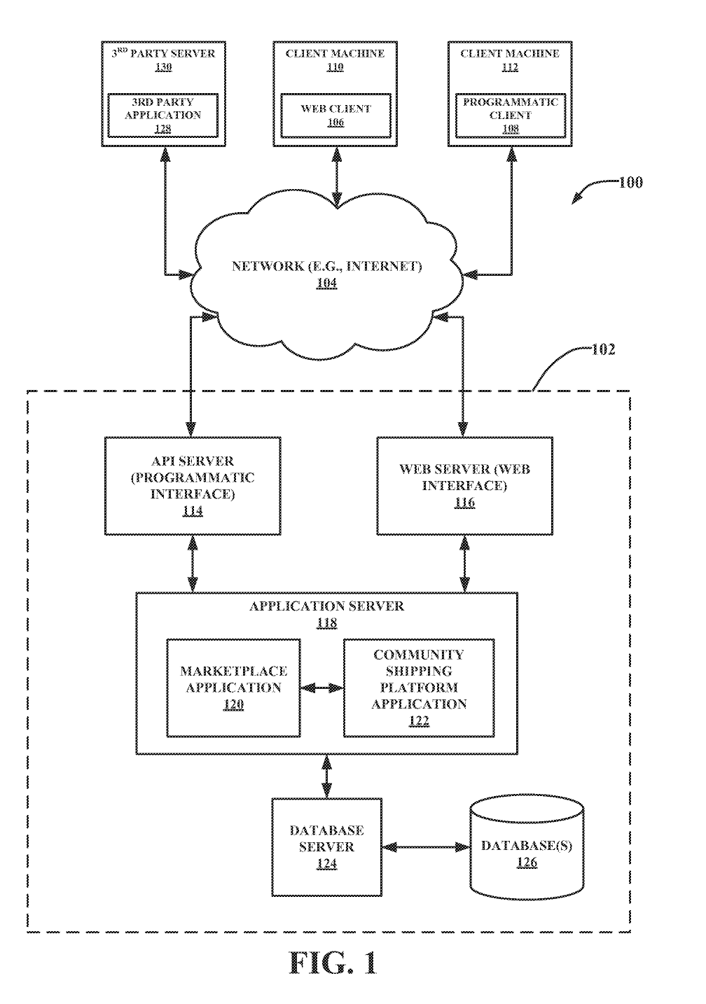

FIG. 1 is a network diagram depicting a network system 100, according to one embodiment, having a client-server architecture configured for exchanging data over a network. For example, the network system 100 may be a publication/publisher system where clients may communicate and exchange data within the network system 100. The data may pertain to various functions (e.g., online item purchases) and aspects (e.g., managing content and user reputation values) associated with the network system 100 and its users. Although illustrated herein as a client-server architecture as an example, other embodiments may include other network architectures, such as a peer-to-peer or distributed network environment.

A data exchange platform, in an example form of a marketplace application 120 and a community shipping platform application 122, may provide server-side functionality, via a network 104 (e.g., the Internet) to one or more clients. The one or more clients may include users that utilize the network system 100 and more specifically, the marketplace application 120 and the community shipping platform application 122, to exchange data over the network 104. These transactions may include transmitting, receiving (communicating) and processing data to, from, and regarding content and users of the network system 100. The data may include, but are not limited to, content and user data such as user profiles; user attributes; product and service reviews and information, such as pricing and descriptive information; product, service, manufacturer, and vendor recommendations and identifiers; product and service listings associated with buyers and sellers; auction bids; and transaction data such as collection and payment, shipping transactions, shipping label purchases, and real time synchronization of financial journals, among others.

In various embodiments, the data exchanges within the network system 100 may be dependent upon user-selected functions available through one or more client or user interfaces (UIs). The UIs may be associated with a client machine, such as a client machine 110 using a web client 106. The web client 106 may be in communication with the marketplace application 120 via a web server 116. The UIs may also be associated with a client machine 112 using a programmatic client 108, such as a client application, or a third party server 130 with a third party application 128. It can be appreciated that in various embodiments the client machines 110, 112, or third party server 130 may be associated with a buyer, a seller, a third party electronic commerce platform, a payment service provider, a shipping service provider, a financial institution system, each in communication with the network-based publisher 102 and optionally each other. The buyers and sellers may be any one of individuals, merchants, or service providers, among other things.

Turning specifically to the marketplace application 120 and the community shipping platform application 122, an application program interface (API) server 114 and a web server 116 are coupled to, and provide programmatic and web interfaces respectively to, one or more application servers 118. The application server 118 hosts one or more marketplace applications 120 and the community shipping platform application 122. The application server 118 is, in turn, shown to be coupled to one or more database servers 124 that facilitate access to one or more database(s) 126.

In one embodiment, the web server 116 and the API server 114 communicate and receive data pertaining to listings and transactions, among other things, via various user input tools. For example, the web server 116 may send and receive data to and from a toolbar or webpage on a browser application (e.g., web client 106) operating on a client machine (e.g., client machine 110). The API server 114 may send and receive data to and from an application (e.g., programmatic client 108 or third party application 128) running on another client machine (e.g., client machine 112 or 3^{rd} party server 130).

In one embodiment, the marketplace application 120 provides listings and price-setting mechanisms whereby a user may be a seller or buyer who lists or buys goods and/or services (e.g., for sale) published on the marketplace application 120.

In one embodiment, the community shipping platform application 122 includes a system and a method for generating and operating a community shipping platform for the marketplace application 120. For example, community shippers may include individuals residing in various geographical locations who are available to help fulfill a shipment of an item between a buyer and a seller by picking up the item at a seller-specified location and dropping it off at a buyer-specified location. For example, an item listed with the marketplace application 120 may be received at the buyer the same day or within hours of after the purchase. In another embodiment, the community shipping platform may operate independently from the marketplace application 120. In other words, another marketplace or system may be able to communicate with the community shipping platform and utilize the resources of the community shippers.

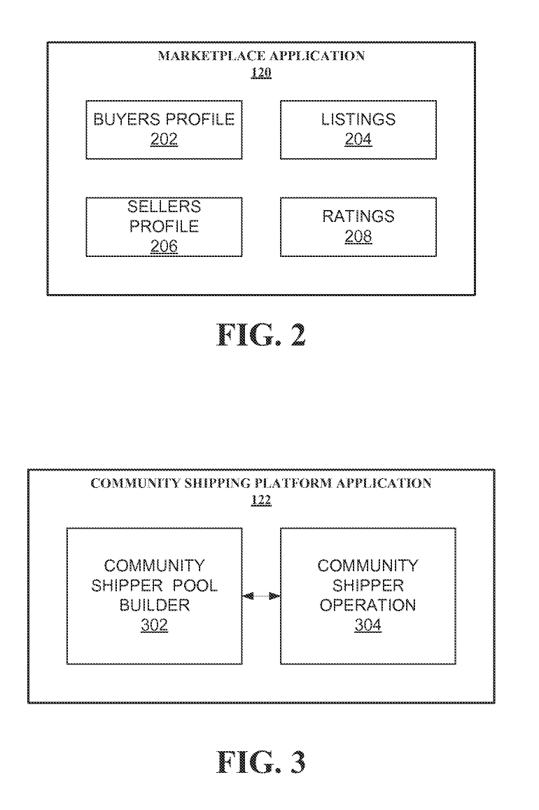

FIG. 2 shows a block diagram illustrating one example embodiment of the marketplace application 120. The marketplace application 120 includes, for example, a buyers profile module 202, a sellers profile module 204, a listings module 206, and a ratings module 208.

The buyers profile module 202 may be configured to generate and store profiles of buyers of the marketplace application 120. For example, the profiles of the buyers may include names, addresses (including shipping address), and transaction history.

The sellers profile module 204 may be configured to generate and store profiles of sellers of the marketplace application 120. For example, the profiles of the seller may include names, addresses (including shipping address), and transaction history.

The listings module 206 may be configured to generate and store listings from the sellers. The listings may identify items for sale in the marketplace application 120.

The ratings module 208 may be configured to generate and store ratings, including feedback ratings of buyers and sellers. In another embodiment, the ratings module 208 may also be configured to generate transaction volume and shipping volume on the marketplace application 120, or any other online marketplace.

FIG. 3 shows a block diagram illustrating one example embodiment of the community shipping platform application 122. The community shipping platform application 122 may include a community shipper pool builder module 302, and a community shipper operation module 304.

The community shipper pool builder module 302 may identify a pool of community shippers operating within a geographical area including a geographical pickup location of a seller and a geographical delivery location of a buyer. In one embodiment, community shippers provide the community shipper pool builder module 302 with the geographic area, distance, and time they would operate. For example, a community shipper may specify that he or she may help fulfill a shipment of an item within a neighborhood, from one neighborhood to another, within a geographical zone, such as a zip code, within a distance radius of a residence of the community shipper, and so forth. The community shipper may also specify the times of his or her availability. For example, a community shipper may be available to service a particular neighborhood on the weekend between the hours of 8 am and 5 pm.

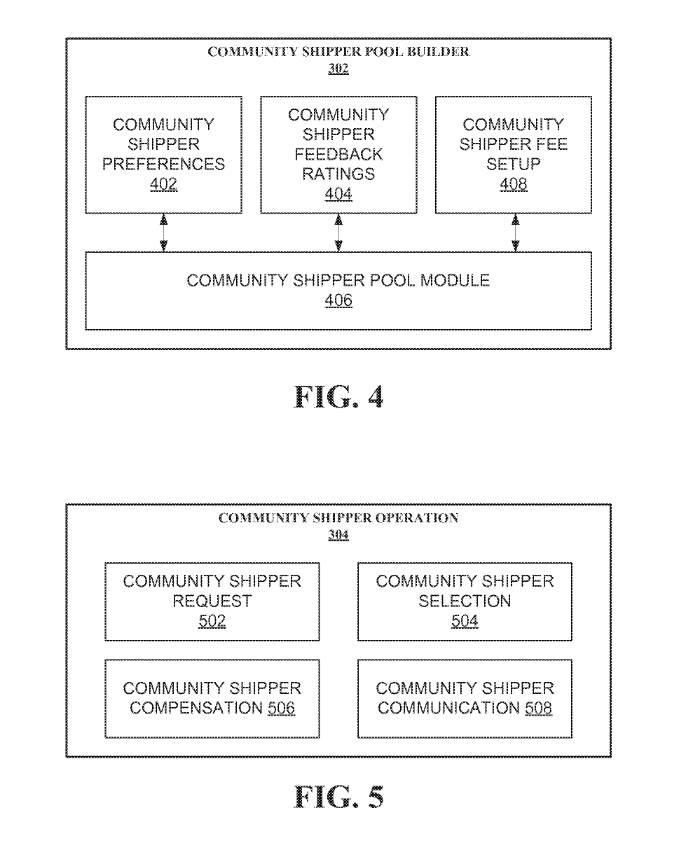

In another embodiment, the community shipper pool builder module 302 may identify community shippers based on corresponding feedback ratings of the community shippers, or other criteria such as shipping item weight or dimensions limit, shipping fee, or added services (e.g., packaging services for the seller—the community shipper shows up at the seller, provides packaging material, and package the item for the seller). An example embodiment of the community shipper pool builder module 302 is described in more details below with respect to FIG. 4.

The community shipper operation module 304 may generate a request to the pool of community shippers to fulfill a shipment from the geographical pickup location of the seller to the geographical delivery location of the buyer. For example, the community shipper operation module 304 may provide a communication and location tracking platform for the community shipper to coordinate a pick up time with the seller and a delivery time with the buyer, and to track a location of the community shipper. The community shipper operation module 304 may further compute and generate a compensation for the community shipper upon confirmation of delivery of the shipment at the buyer-specified location. An example embodiment of the community shipper operation module 304 is described in more details below with respect to FIG. 5.

FIG. 4 shows a block diagram illustrating one example embodiment of the community shipper pool builder module 302. The community shipper pool builder module 302 may include a community shipper preferences module 402, a community shipper feedback ratings module 404, a community shipping pool module 406, and a community shipper fee setup module 408.

The community shipper preferences module 402 may include preferences for geographic operating distances and operating times for each community shipper. In another embodiment, a community shipper may also specify his or her current location and radius of operation within the current location.

The community shipper fee setup module 408 may compute a community shipping fee based on the geographic operating distances, the geographical area, and operating times. For example, the community shipping fee may be higher during peak traffic hours, or at night time. The community shipping fee may be higher for neighborhood with a higher crime rate. In another embodiment, the community shipper preferences module 402 may also include weight, dimensions, or value limits from the community shippers. For example, a community shipper may wish to limit the weight of the item he or she is willing carry. In another embodiment, the community shipper fee may be specified by the seller and/or further determined by the online marketplace based on other factors such as the ones previously listed.

The community shipper feedback ratings module 404 may include a feedback rating for each community shipper based on previous community shipping deliveries. Buyers and sellers may contribute to the rating of the community shipper.

The community shipping pool module 406 may identify the pool of community shippers based on the geographic operating distances, operating times, and feedback rating of each community shipper. In other words, the community shipping pool module 406 may filter out community shippers that do not belong in a geographic area local to the buyer or seller, or who cannot pick up or deliver at the times provided by the buyer or seller, or who cannot accommodate the dimensions or weight of the shipment. The selection of community shippers may also be based on fees specified by the community shippers and their current geographical position (if available).

FIG. 5 shows a block diagram illustrating one example embodiment of the community shipper operation module 304. The community shipper operation module 304 may include a community shipper request module 502, a community shipper selection module 504, a community shipper compensation module 506, and a communication shipper communication module 508.

The community shipper request module 502 generates the request to the pool of community shippers. For example, the request may identify the geographical pickup location of the seller, the geographical delivery location of the buyer, a pickup timeframe from the seller, and a delivery timeframe from the buyer. For example, the community shipper request module 502 may segment the community shipper pool into segments based on desirable characteristics such as feedback ratings and fees. Then, the community shipper request module 502 reaches out to the highest priority segment first. If no community shipper accepts the request, the community shipper request module 502 extends the offer to the next segment and so on in succession. There may be a brief time allowed for community shippers in one segment to respond before the offer is extended to the next segment until the entire community shipper pool is exhausted.

The community shipper selection module 504 may select one of the community shippers from the pool of community shippers who has replied to the request. For example, the community shipper selection module 504 may select the community shipper first to reply to the request. In another embodiment, community shippers may set up a preference such that the community shippers automatically respond by accepting or declining a community shipping job request. In such case of auto response, it is possible for multiple acceptances in parallel. In such tie situations, the community shipper selection module 504 may apply some rules (based on qualities such as feedback, etc.) to decide who gets the community shipping job. The community shipper selection module 504 may also consider previous job assignments to determine who gets new job so that all shippers who are available get assignments eventually and no one is left out.

The community shipper compensation module 506 computes and generates a compensation for the selected community shipper upon verification of delivery of the shipment at the geographical delivery location of the buyer.

The community shipper communication module 508 may establish a pickup time coordination communication between the selected community shipper and the seller, and a delivery time coordination communication between the selected community shipper and the buyer.

In one embodiment, the community shipper communication module 508 may communicate the geographical pickup location of the seller and the geographical delivery location of the buyer to the selected community shipper.

In another embodiment, the community shipper communication module 508 may generate a shipment status based on a geographic location of a mobile device of the selected community shipper. In another embodiment, if the seller or the buyer is at a location different from their registered addresses, the communication module can help the community shipper locate the buyer and the seller based on the position of their mobile devices in the map. For example, the buyer may be at his work address several miles away from his residence address where he registered to receive packages. The community shipper may delivery the package at the work address of the buyer based on the current location of the buyer at his work.

In another embodiment, the community shipper communication module 508 may track a geographic location of the mobile device of the selected community shipper, and may communicate the geographic location of the mobile device of the selected community shipper to the buyer and the seller.

In another embodiment, the community shipper communication module 508 may compute an estimated pick up time and an estimated delivery time based on the geographic location of the mobile device of the selected community shipper, and may generate a notification of the estimated pick up time and the estimated delivery time to the buyer and the seller. The estimated pick up time and delivery time may be further adjusted based on real time traffic information and other factors such as weather, time of the day, week, and so forth.

In another embodiment, the community shipper communication module 508 may receive confirmation of a pickup and a delivery from the selected community shipper, and may provide confirmation of the pickup and the delivery to the buyer and the seller.

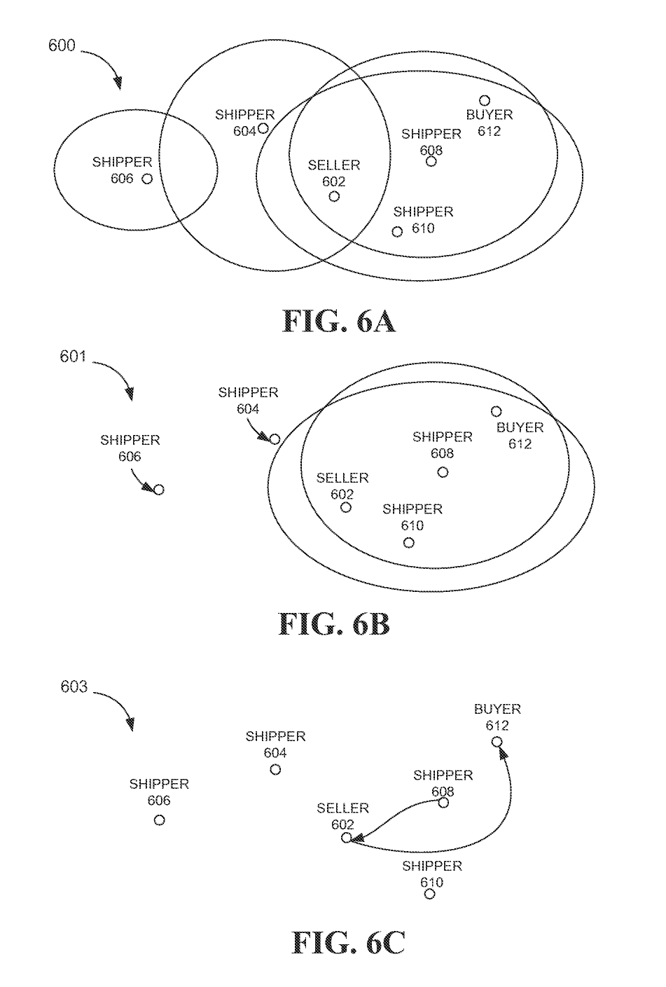

FIG. 6A shows a block diagram illustrating one example of a pool of community shippers 600 in a geographic area. Community shippers 600 includes shipper 604, 606, 608, and 610 geographically local to seller 602 and buyer 612. The geographic area operated by each shipper is illustrated as a corresponding ellipse or circle around each shipper. For example, shipper 606 does not operate within a geographic area of the seller 602. Shipper 604 operates within a geographic area of the seller 602 but not of the buyer 612. Shippers 608 and 610 operate within a geographic area of both the seller 602 and the buyer 612. As such, the community shipper pool builder 302 may generate a pool of community shippers comprising shippers 608 and 610.

FIG. 6B shows a block diagram illustrating one example of a request to a pool of community shippers (608 and 610) in a geographic area of both the buyer 612 and the seller 602. For example, the community shipping platform application may generate a request to both community shippers 608 and 610 to pick up an item from seller 602 and deliver it to the buyer 612.

FIG. 6C shows a block diagram illustrating one example of an operation of community shipper platform. In this example, the community shipping platform application has selected shipper 608 to fulfil the shipment. Thus, the shipper 608 picks up the item from the seller 602 and delivers it to the buyer 612.

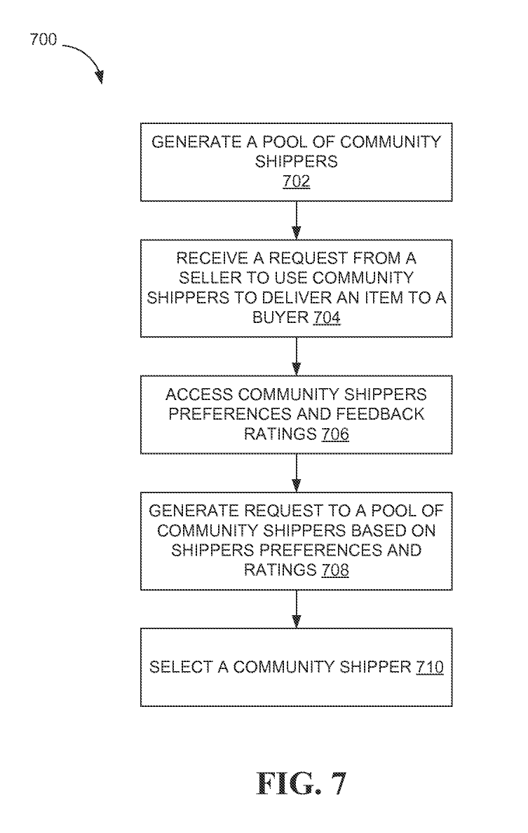

FIG. 7 shows a flow diagram illustrating one example embodiment of a method 700 for generating a pool of community shippers. At operation 702, a pool of community shipper's is generated based on (preferences, the geographic location of both the buyer and the seller, the operating geographic area of the community shippers, and the operating hours of the community shippers.

At operation 704, a request is received from a seller to use a community shipper to deliver an item to a buyer. For example, the seller has listed an item for sale in an online marketplace. A commercial transaction is generated between the seller and the buyer. In particular, the commercial transaction specifies that a community shipper is to pick up the item from the seller and deliver it to the buyer.

At operation 706, the community shipping platform application accesses preferences and feedback ratings for the community shippers.

At operation 708, the community shipping platform application generates a request to a pool of community shippers based on the community shippers preferences and the feedback ratings.

At operation 710, the community shipping platform application selects a community shipper.

In another example embodiment, a seller can choose CSP shippers as an option, regardless of availability of CSP shippers at listing time. This is because a sale has not yet happened and availability of CSP shippers may change from listing to sale time. At the time of sale, a buyer can choose CSP shipping, if the seller of the item has chosen CSP as an available option and a CSP shipper is potentially available. Once this is done, the community shipping platform application 122 will try to locate and assign the shipping job to a CSP shipper. Until then it is not guaranteed that the buyer will get item delivered via CSP. Therefore, the community shipping platform application 122 calculates the chances that it can find a CSP shipper. If the chances are low (though available), the buyer should be asked to choose a backup shipping option such as a regular shipping through USPS or others.

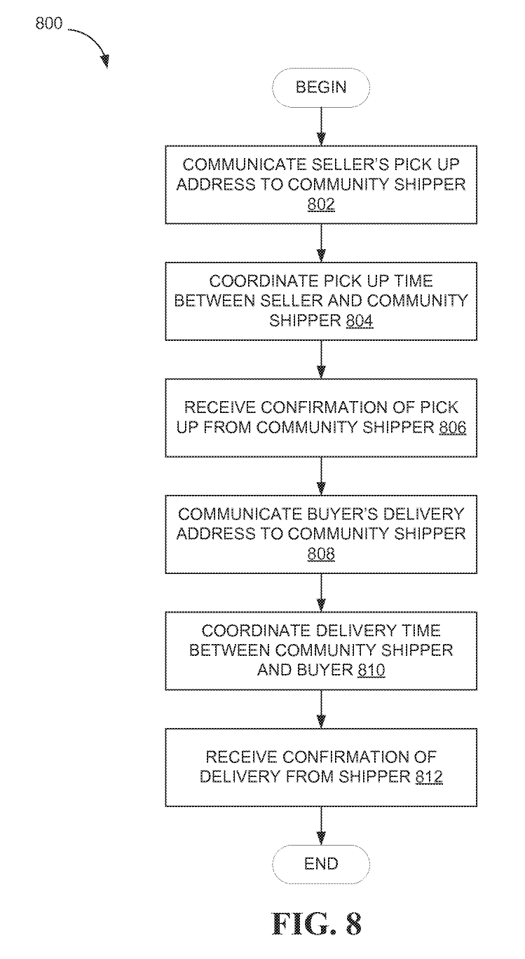

FIG. 8 shows a flow diagram illustrating one example embodiment of a method 800 for operating a community shipper platform. At operation 802, the community shipping platform application communicates the seller's pickup address to a selected community shipper. At operation 804, the community shipping platform application coordinates a pickup time between the seller and the selected community shipper. At operation 806, the community shipping platform application receives a confirmation of pickup from the selected community shipper. At operation 808, the community shipping platform application communicates the buyers delivery address to the selected community shipper. At operation 810, the community shipping platform application coordinates a delivery time between the selected community shipper and the buyer. At operation 812, the community shipping platform application receives a confirmation of delivery from the selected community shipper.

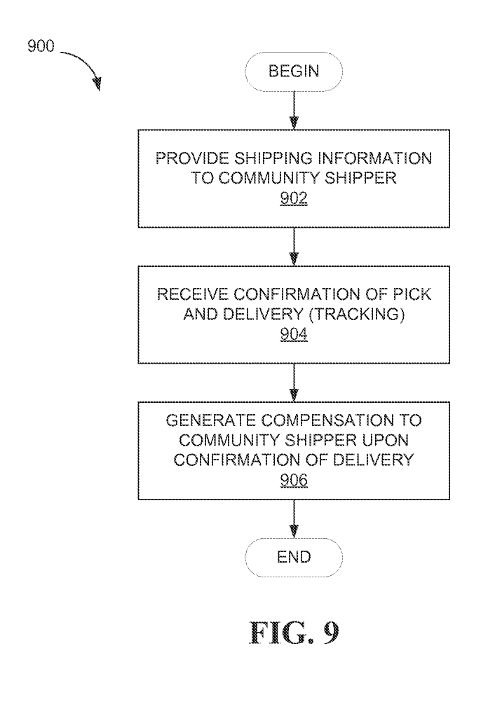

FIG. 9 shows a flow diagram illustrating one example embodiment of a method 900 for generating a compensation for a community shipper. At operation 902, shipping information is provided to a selected community shipper. At operation 904, confirmation of pickup and delivery and tracking information may be received. At operation 906, compensation is generated to the selected community shipper upon confirmation of delivery of the item at the buyer's location. A variety of pricing schemes are possible in CSP. A flat rate could be charged by eBay to buyers and shared between eBay and shipper, where the majority of the amount goes to shipper. Shipper may be compensated for his/her cost (that includes time, fuel, vehicle, etc.) a profit. eBay may choose to not charge any fee for shipper so as to improve CSP usage and thus local market transactions, where it can get seller fees. Another alternative is to let shippers set the price and thus promote competition. In both cases, eBay could generate revenue mainly from regular marketplace seller fees and it could get from shipper fees as well.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously; communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 11) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

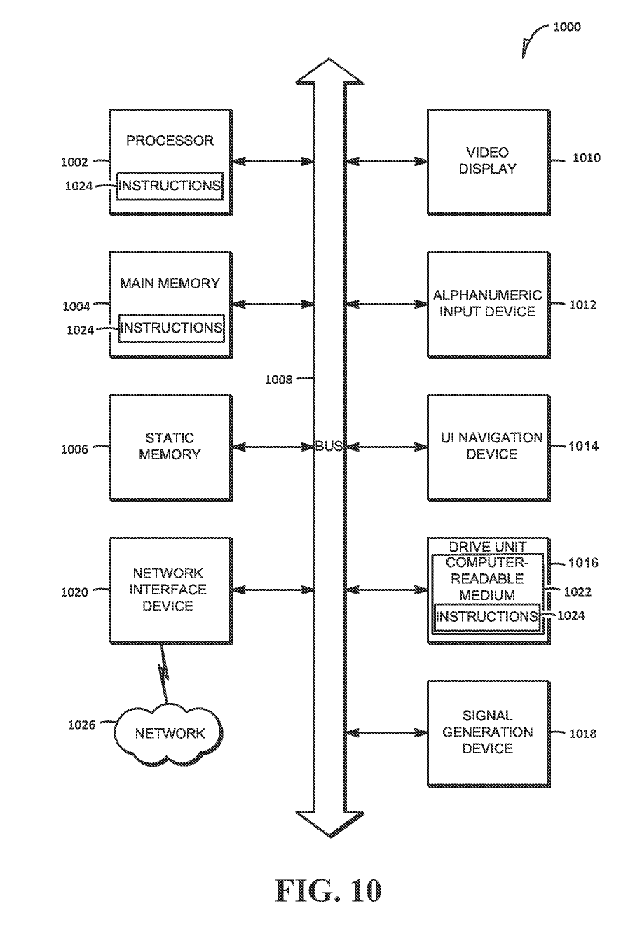

FIG. 10 is a block diagram of a machine in the example form of a computer system 1000 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (CPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation (or cursor control) device 1014 (e.g., a mouse), a disk drive unit 1016, a signal generation device 1018 (e.g., a speaker) and a network interface device 1020.

### Machine-Readable Medium

The disk drive unit 1016 includes a machine-readable medium 1022 on which is stored one or more sets of data structures and instructions 1024 (e.g., software) embodying or utilized by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media. The instructions 1024 may also reside, completely or at least partially, within the static memory 1006.

While the machine-readable medium 1022 is shown in an example embodiment to be a single medium, the term “machine-readable medium” may include a single medium or multiple media (e.g., a centralized or distributed database, and/or associated caches and servers) that store the one or more instructions 1024 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed:

1. A community shipping platform system comprising:
at least one processor;
a community shipper pool builder module, implemented by the at least one processor, configured to identify a pool of community shippers operating within a geographical area including a geographical pickup location of a seller and a geographical delivery location of a buyer; and
a community shipper operation module, implemented by the at least one processor, configured to generate a request to the pool of community shippers to fulfill a shipment from the geographical pickup location of the seller to the geographical delivery location of the buyer.

2. The community shipping platform system of claim 1, wherein the community shipper pool builder module comprises a community shipper preferences module, a community shipper feedback ratings module, and a community shipping selection module,
the community shipper preferences module comprising geographic operating distances and operating times for each community shipper,
the community shipper feedback ratings module comprising a feedback rating for each community shipper, and
the community shipping selection module configured to identify the pool of community shippers based on the geographic operating distances, operating times, and feedback rating of each community shipper.

3. The community shipping platform system of claim 2, wherein the community shipper operation module comprises a community shipper request module, a community shipper selection module, a community shipper compensation module, a communication shipper communication module,
the community shipper request module configured to generate the request to the pool of community shippers, the request identifying the geographical pickup location of the seller, the geographical delivery location of the buyer, a pickup timeframe from the seller, and a delivery timeframe from the buyer.
the community shipper selection module configured to select one of the community shippers from the pool of community shippers who has replied to the request,
the community shipper compensation module configured to compute and generate a compensation for the selected community shipper upon verification of delivery of the shipment at the geographical delivery location of the buyer, and
the community shipper communication module configured to establish a pickup time coordination communication between the selected community shipper and the seller, and a delivery time coordination communication between the selected community shipper and the buyer.

4. The community shipping platform system of claim 1, wherein the pool of community shippers operates for buyers and sellers in an online marketplace.

5. The community shipping platform system of claim 3, wherein the community shipper communication module is configured to communicate the geographical pickup location of the seller and the geographical delivery location of the buyer to the selected community shipper.

6. The community shipping platform system of claim 3, wherein the community shipper communication module is configured to generate a shipment status based on a geographic location of a mobile device of the selected community shipper.

7. The community shipping platform system of claim 6, wherein the community shipper communication module is configured to track a geographic location of the mobile device of the selected community shipper, and communicate the geographic location of the mobile device of the selected community shipper to the buyer and the seller.

8. The community shipping platform system of claim 7, wherein the community shipper communication module is configured to compute an estimated pick up time and an estimated delivery time based on the geographic location of the mobile device of the selected community shipper, and generate a notification of the estimated pick up time and the estimated delivery time to the buyer and the seller.

9. The community shipping platform system of claim 3, wherein the community shipper communication module is configured to receive confirmation of a pickup and a delivery from the selected community shipper, and to provide confirmation of the pickup and the delivery to the buyer and the seller.

10. The community shipping platform system of claim 3, wherein the community shipper preferences module comprises a shipping fee based on the geographic operating distances, the geographical area, and operating times.

11. A method for a community shipping platform system comprising:
identifying, using at least one processor, a pool of community shippers operating within a geographical area including a geographical pickup location of a seller and a geographical delivery location of a buyer; and
generating a request to the pool of community shippers to fulfill a shipment from the geographical pickup location of the seller to the geographical delivery location of the buyer.

12. The method of claim 11, further comprising:
determining geographic operating distances and operating times for each community shipper;
determining a feedback rating for each community shipper; and
identifying the pool of community shippers based on the geographic operating distances, operating times, and feedback rating of each community shipper.

13. The method of claim 12, further comprising:
generating the request to the pool of community shippers, the request identifying the geographical pickup location of the seller, the geographical delivery location of the buyer, a pickup timeframe from the seller, and a delivery timeframe from the buyer;
selecting one of the community shippers from the pool of community shippers who has replied to the request;
computing a shipping fee based on the geographic operating distances, the geographical area, and operating times of the selected community shipper;
generating a compensation for the selected community shipper upon verification of delivery of the shipment at the geographical delivery location of the buyer; and
establishing a pickup time coordination communication between the selected community shipper and the seller, and a delivery time coordination communication between the selected community shipper and the buyer.

14. The method of claim 11, wherein the pool of community shippers operates for buyers and sellers in an online marketplace.

15. The method of claim 13, further comprising:
communicating the geographical pickup location of the seller and the geographical delivery location of the buyer to the selected community shipper.

16. The method of claim 13, further comprising:
generating a shipment status based on a geographic location of a mobile device of the selected community shipper.

17. The method of claim 16, further comprising:
tracking a geographic location of the mobile device of the selected community shipper; and
communicating the geographic location of the mobile device of the selected community shipper to the buyer and the seller.

18. The method of claim 17, further comprising:
computing an estimated pick up time and an estimated delivery time based on the geographic location of the mobile device of the selected community shipper; and
generating a notification of the estimated pick up time and the estimated delivery time to the buyer and the seller.

19. The method of claim 13, further comprising:
receiving confirmation of a pickup and a delivery from the selected community shipper; and
providing confirmation of the pickup and the delivery to the buyer and the seller.

20. A non-transitory computer-readable storage medium storing a set of instructions that, when executed by a processor, cause the processor to perform operations, comprising:
identifying, using at least one processor, a pool of community shippers operating within a geographical area including a geographical pickup location of a seller and a geographical delivery location of a buyer; and
generating a request to the pool of community shippers to fulfill a shipment from the geographical pickup location of the seller to the geographical delivery location of the buyer.
